(19) United States
(12) Patent Application Publication
(10) Pub. No.: US 2012/0008728 A1
(43) Pub. Date: Jan. 12, 2012

(54) Resonant Vacuum Arc Discharge Apparatus for Nuclear Fusion

(75) Inventor: Ray R. Fleming, Austin, TX (US)

(73) Assignee: Ray R. Fleming, Austin, TX (US)

(21) Appl. No.: 12/833,588

(22) Filed: Jul. 9, 2010

(51) Int. Cl. G21B 1/00

(52) U.S. Cl. 376/144

(57) ABSTRACT

The present invention relates to a resonant vacuum arc discharge apparatus for producing nuclear fusion. A resonant high-frequency high-voltage alternating current (AC) power supply is used to efficiently power a fusion tube normally containing deuterium, tritium and/or helium-3 vapor. Metals that can hold large amounts of hydrogen isotopes such as palladium and titanium can be used to increase the target density. The nuclear fusion device can be used for energy production, well logging, uranium mining, neutron activation analysis, isotope production or other applications that require a neutron source.

### CROSS-REFERENCE

There are no related patent applications

### STATEMENT REGARDING FEDERALLY SPONSORED RESEARCH

All development of the enclosed invention was conducted at the inventor's expense with no government assistance.

### PARTIES TO THE INVENTION

The inventor, Ray R. Fleming possesses all rights to the invention.

### BACKGROUND OF THE INVENTION

Energy production by nuclear fusion would be one of the most important developments in science, but the development of the technology has been much slower than hoped. In the mean time neutrons produced by smaller fusion accelerators are being used for such things as well logging of oil and gas wells, uranium mining, neutron activation analysis and potentially radioisotope production. All of these fields could use a more energy efficient means of achieving fusion.

The first deuterium (D) fuel fusion device was reported by Oliphant and Rutherford in 1934. It was little different from the accelerators of today. It had a high voltage power supply supplying direct current (DC) to an evacuated chamber. Deuterium gas was introduced to the system where it could be accelerated. Some of the deuterons, called diplons in the report, collided and fused. Two different fusion products were reported; tritium and a proton, and helium-3 and a neutron. The experimenters reported fusion at voltages as low as 20,000 volts and reported that at 100,000 volts they could no longer measure the results as the effect was too large to measure.

Modern accelerators generally rely on deuterium-tritium fusion to produce neutrons. Tritium (T) is introduced to a target material that can absorb the heavy hydrogen isotope. Titanium is the most common target material in accelerators, but scandium and palladium are also well known hydrogen absorbers that are useful as accelerator targets. The target is mounted in an evacuated tube and attached to the ground or negative potential side of the high-voltage power supply. The ideal energy for D-T fusion is very close to 100,000 volts, which is the typical operating voltage. Lower voltages, as low as 10,000 volts can be used when lower neutron output is adequate. Deuterium gas is then introduced to the evacuated tube where it accelerates toward the tritiated target. D-T fusion reactions occur producing helium-4 and a neutron. These high-energy neutrons are useful in some commercial applications.

In the oil and gas industry, oilfield service companies have long used neutron sources for well logging to identify zones of the well that have hydrogenous material, oil and water. The most common neutron source is composed of a mixture of americium-241 and beryllium (AmBe), which gives off neutrons when the beryllium atoms absorb an alpha particle from the Am-241 and then decays. Am-241 only available from Russia currently and could be used in radiological dispersive devices, so the industry is seeking alternatives Tritium target fusion accelerator tubes are being used to a limited degree, but suffer from a short working life. A D-D fusion accelerator would be beneficial since deuterium does not have to be licensed as radioactive material. Another advantage is that D-D neutrons (2.45 MeV) are also more similar in energy to the AmBe neutrons (−4 MeV) than the much higher energy D-T neutrons (14.1 MeV) thus making result comparisons easier. A current disadvantage with D-D fusion devices is that neutron output is much less than the output from D-T fusion. Other industries require neutron sources for uranium mining, neutron activation analytical equipment and radioisotope production. A more efficient D-T accelerator tube or a usable D-D accelerator tube would be a benefit in those industries.

Many scientific research efforts focus on developing magnetic confinement methods to control plasma and produce fusion. None of the numerous variations in this approach have successfully produced net positive energy and are generally too cumbersome to replace accelerators for field use. In general these efforts suffer from the plasma density being too low or beams of plasma not being easily controlled. Laser fusion is technique that currently requires far more energy than it generates, and is not suitable for field use. Both of these methods also suffer because the test apparatus is not conducive to extracting heat for power production.

Another field of interest is Low Energy Nuclear Reactions (LENR), often called cold fusion. LENR can occur when a metal that can hold significant amounts of hydrogen such as palladium is saturated with deuterium. Numerous experimenters have reported that fusion occurs spontaneously in deuterium-saturated palladium. The output is presently far below anything needed for energy production or any other commercial use. LENR research into materials that can contain high concentrations of deuterium and tritium is however applicable to other fusion techniques.

The inventor previously received patents for a resonant power supply for producing vacuum arc discharges, U.S. Pat. No. 6,630,799, and for a vacuum arc discharge apparatus for the efficient production of x-rays, U.S. Pat. No. 6,765,987. These devices used a high-voltage resonant circuit attached to the cold cathode electrodes of a partially evacuated tube in order to produce x-rays. The resonant AC circuit was significantly more efficient than a DC powered x-ray source of the same voltage and energy. The x-ray tube in its preferred embodiment used a noble gas such as xenon or argon at pressures in the low millitorr range.

A search of prior art failed to reveal any record of the use of resonant alternating current power sources in an accelerator type device for the production of fusion or neutrons as described in the present invention. The following prior art patents were reviewed:
1. U.S. Pat. No. 7,342,988 to Leung et al., Neutron Tubes
2. U.S. Pat. No. 6,922,455 to Jurczyk et al., Gas-Target Neutron Generation and Applications
3. U.S. Pat. No. 4,996,017 to Ethridge, Neutron Generator Tube
4. U.S. Pat. No. 4,244,782 to Dow Nuclear Fusion System
5. U.S. Pat. No. 3,417,245 to Schmidt, Neutron Generating Apparatus
6. U.S. Pat. No. 3,386,883 to Farnsworth, Method and Apparatus for Producing Nuclear Fusion Reactions
7. U.S. Pat. No. 3,246,191 to Fentrop, Neutron Generating Discharge Tube
8. U.S. Pat. No. 3,117,912 to Imhoff et al., Method of Producing Neutrons
9. U.S. Pat. No. 3,016,342 to Kruskal et al., Controlled Nuclear Fusion Reactor
10. U.S. Pat. No. 2,983,820 to Fentrop, Well-Logging Apparatus
11. U.S. Pat. No. 2,973,444 to Dewan, Neutron Source for Well Logging Apparatus
12. U.S. Pat. No. 2,489,436 to Salisburu, Method and Apparatus for producing Neutrons
13. U.S. Pat. No. 2,240,914 to Schutze, Device for Converting Atoms

### REFERENCE

M. L. Oliphant et al., Transmutation Effects Observed with Heavy Hydrogen, Nature, 133, p 413 (Mar. 17, 1934).

### BRIEF SUMMARY OF THE INVENTION

The device in accordance with an embodiment of the present invention consists of a high-efficiency resonant high-voltage AC power source and vacuum arc discharge tube for achieving nuclear fusion. The tube consists of an envelope made of a suitable non-conductive material with electrodes mounted through opposing sides of the tube, and the tube is filled with a low-pressure vapor consisting of atoms that can be fused such as deuterium, tritium and/or helium-3. The high voltage resonant power supply generates high-frequency alternating current (AC). Arcs are formed between the electrodes when the potential reaches a high enough voltage, the breakdown voltage for the apparatus. During an arc the electrons are accelerated toward the positive electrode and the ions are accelerated toward the negative electrode.

The electrodes absorb some of the ions, and in this manner the system generates its own fusion targets. Because the system operates in AC, ions move back and forth and both electrodes become replenishable fusion targets. After a few cycles the fusion ions accelerated toward the electrode will strike other fusion ions on the surface of the electrodes producing nuclear fusion. Some additional fusion events will occur within the plasma, but at a far lesser rate.

The operation of this fusion apparatus is similar in many ways to the most modern designs for fluorescent lamps, neon lights, or flash lamps, except that the vapor pressure is much lower and the voltage much higher. To improve the efficiency while reducing size and cost of the power supply, the present invention incorporates high-frequency resonant inverter technology into the supply with the addition of a high-frequency high-voltage transformer. In order to achieve fusion efficiently, a power supply must be used that is capable of delivering hundreds of watts of power at a hundred kilovolts or more.

It is envisioned that several different atoms can be used for fusion. The highest efficiency interaction is D-T where a mixture of deuterium and tritium vapor is introduced to the tube. In other cases D-D or D-He³ reactions are preferred. Since D-D reactions produce T and He³ there will always be a mix of reactants whenever D is introduced to a fusion tube. The more common fusion reactions between those three atoms will also occur to some degree. The vapor will normally be leaked into the tube at a low rate to maintain constant pressure. This replenishes the ions that are constantly being absorbed by the electrodes. If a vacuum system is used to maintain constant pressure, a leak is required to replenish the ions lost. The leak rate must be controlled to maintain constant pressure within the tube as the arcing voltage is related to the pressure and the arc voltage must be kept fairly constant. Another embodiment requires that the electrodes be saturated with vapor so the vapor is released at the same rate it is absorbed. However, the life of the tube in this embodiment is more limited.

The electrode material used is also important to the invention. Target density is critical to achieving high efficiency with fusion reactions. While tungsten is a popular choice for cold cathode lamps or x-ray tubes due to its high melting point it is a poor absorber of hydrogen isotopes. To improve fusion efficiency, an electrode comprised of a material that is an excellent hydrogen isotope absorber is a preferred embodiment. Palladium, scandium, and titanium are three of the best elements for that purpose, with palladium being the best performer and titanium a good lower cost option. The hydrogen density of hydrated palladium can approach that of liquefied hydrogen. Fusion techniques relying on plasmas can never approach those target densities.

Improved electrode shape is another important embodiment of the invention. Most cold cathode lamps use conically shaped electrodes. The tips of these electrodes melt and vaporize and become rounded as a result of repeated arcing. As the tips become more rounded, higher voltage is required to sustain the arcs. Tip rounding also spreads out the fusion target area reducing the probability of fusion events occurring. In the preferred embodiment the invention incorporates hollow electrodes. They are thin enough to remain consistently sharp at the edge as they vaporize so the arcing voltage remains more consistent. Hollow electrodes also present a smaller target area and more consistent cross section so the rate of fusion is greater and stays constant. Hollow electrode vacuum arc discharge systems have been shown experimentally to have a higher light and x-ray output than solid electrodes for a given energy input. This improved efficiency is also realized when hollow electrodes are used for fusion.

Enhanced tube envelope material and design is another aspect to the invention. Modifications from a basic cylindrical tube shape can improve longevity and heat transfer. One of the failure modes of an accelerator tube fusion device is that vaporized electrode material plates out along the tube body forming a ground path. The tube can be designed with corrugations or rings to break up the electrical continuity of the plated areas and thereby extend tube life. The envelope designed can include fins on the outside to increase surface area for more rapid heat transfer. The envelope will also function as an electrical insulator to prevent the tube from being electrically grounded. An important embodiment of this invention with respect to energy generation is that a tube must have proper electrical insulation so it can be immersed directly in water, or other heat transfer fluid so that both heat due to fusion and waste heat can be used for electrical production.

The use of a resonant AC power supply is perhaps the most important aspect to the invention. The greatest gains can be achieved by using AC rather than the DC typically used in a fusion accelerator tube. Keeping in mind that the ions are accelerated at near light speed, the vapor in a tube is accelerated in less than a few of nanoseconds. AC operation produces arcs in alternate directions that shut down between pulses. The more rapidly the arcs are quenched and the magnetic field collapses, the more energetic the pulses generated and greater the fusion output produced. As the number or arcs per second increases, the output increases. If the coil or coils connected to the tube can be made to resonate, then unconverted energy can be stored and passed back through the tube multiple times further improving efficiency.

The embodiment of the resonant power supply is a designed where the stage of the high-voltage power supply between the high-frequency inverter and the fusion tube is a resonant RLC (Resistance-Inductance-Capacitance) circuit. These circuits can be very efficient with almost all the energy going into the inverter being available for arc production. In the preferred embodiment of the invention, high-voltage resonator coils along with some additional capacitance are placed on opposite sides of the arc path so that arcs can resonate back and forth at very high frequency independent of the inverter or transformer.

### BRIEF DESCRIPTION OF THE DRAWINGS

For a more complete understanding of the present invention and the advantages thereof, reference is now made to the following descriptions taken in conjunction with the accompanying drawings. In the drawings, depicted elements are not necessarily drawn to scale and like or similar elements may be designated by the same reference numeral throughout the several views.

FIG. 1 shows a fusion tube design according to the present invention with some additional embodiments of the invention.

FIG. 2 shows another fusion tube design according to the present invention with some additional embodiments of the invention.

FIG. 3 shows a fusion tube and resonant high-frequency high-voltage power supply including many additional embodiments of the invention with respect to coils and transformers.

FIG. 4 illustrates the fundamental invention with the minimum number of components.

FIG. 5 illustrates a transformer with a single primary coil and two secondary coils.

### DETAILED DESCRIPTION OF THE INVENTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

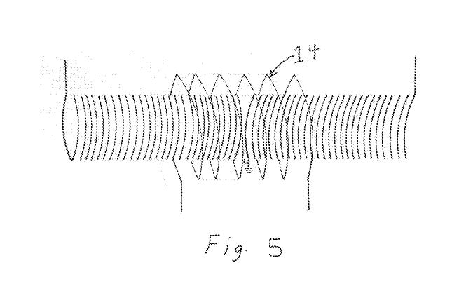

The device in accordance with an embodiment of the present invention as illustrated in FIG. 4 consists of a high frequency inverter (13), a resonant coil (12), and a fusion tube comprising of an envelope (1), two electrodes (2) and vapor (3). The high frequency inverter produces alternating current (AC) from a direct current (DC) source. The DC voltage will generally be in the 400 volt to 4000 volt range, with the upper range increasing as high-voltage inverter technology improves. The input voltage can be positive or negative with respect to ground or both positive and negative with respect to ground depending on the coil and/or transformer arrangement. As technology improves higher voltage switching devices, such as MOSFETs, IGBTs, are becoming more common allowing for fusion to be achieved without a transformer. A simple coil can increase the voltage to the 10,000 volts required for fusion. In most cases one or two transformers will be used so that higher voltages and in turn efficiencies are achieved. A more in-depth description of resonant power supply design for producing vacuum arc discharges may be found in the inventor's U.S. Pat. No. 6,630,799.

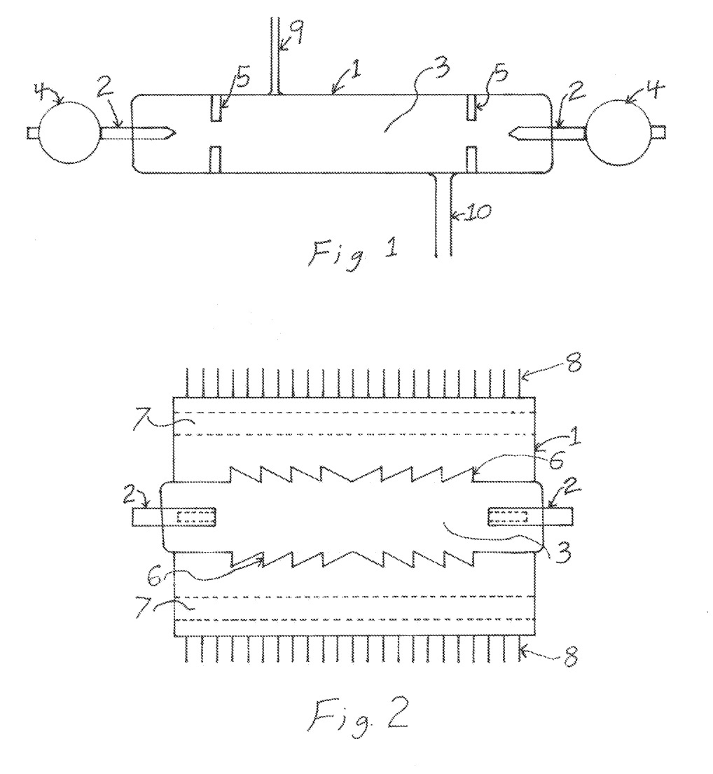

FIG. 1 illustrates some of the basic design principles of a fusion tube designed to fuse atoms when attached to a resonant coil powered by an inverter. The envelope (1) is made of a non-conductive material that can withstand high temperatures, such as quartz, borosilicate, or ceramic. The envelope (1) may be comprised of a compound such as a high lithium content ceramic to act as a breeder material for producing tritium, a method that is well known to the art of nuclear fusion. The envelope may have a smooth internal surface as is common with most arc lamps or have internal features such as rings (5) that prevent metal that is vaporized from the electrodes (2) from depositing along the length of the envelope (1) forming an electrical ground. The rings (5) are shown here as circular pieces with a circular hole in the middle, with the outer edges fused to the wall of the envelope (1). The rings (5) will generally be made of the same material as the envelope. In FIG. 2 corrugations (6) are used to achieve the same effect. The electric current, the arcs, must be conducted through the vapor (3) for optimal fusion. If current is conducted along the walls of the envelope (1), that energy will be largely wasted.

The vapor (3) in one embodiment of the invention is comprised of atoms that are known to fuse, most commonly deuterium (D), tritium (T) and or helium-3 (³He). The three interactions with the highest probability of fusing are D-T, D-D, and D-³He. The highest cross-section for D-T fusion reactions occurs at approximately 100,000 volts, which is easily achieved with a resonant high-frequency high-voltage power supply. Optimal cross-sections for D-D and D-³He are achieved with voltages in excess of 200,000 volts. These can be achieved with some embodiments of the resonant vacuum arc discharge apparatus. Since D-D reactions yield T and ³He each 50% of the time, any fusion tube that contains deuterium will contain all three atoms. There are three other reactions of lesser importance, T-T, ³He-³He and ³He-T. All the reactions other than D-D yield helium-4, which is a stable waste product. A noble gas such as helium, neon, argon or xenon may be added at a small percentage, nominally 1%, as that has been shown to increase energy output in related devices. In a flow through system D, T and ³He should be recovered from the exhaust of the vacuum system for recycling.

In FIG. 1. the electrodes (2) are shown with a simple conical point on the end. The arcing voltage is dependent on the sharpness of the electrode (2) tips, so hard, high melting point materials are preferred. In FIG. 2 an alternative embodiment of the electrodes (2) is shown where the tips are hollow. Hollow electrodes have thin walls to maintain their relative sharpness as the arcs slowly vaporize them. This allows the breakdown voltage to remain constant. They also present a smaller target area to the accelerated vapor, increasing the probability of fusion events occurring. While hollow electrodes are almost always cylindrical, other shapes may be used such as square or rectangular tubing. Sometimes called hollow cathodes, lamps and other discharge apparatus utilizing them have been known to show improved arc characteristics over standard electrodes. There must be a vacuum tight seal of the type well know to the art of lamp making between the envelope (1) and electrodes (2).

Another important aspect to the invention is the selection of electrode (2) material. While tungsten may be preferred for light and x-ray production it is a relatively poor absorber of hydrogen isotopes. For optimal performance under the principle embodiment of the invention the electrode first absorbs D and/or T that are accelerated by the high voltage across the tube so it can then act as a fusion target. The probability of a fusion event goes up with D and/or T density on or near the surface of the electrode. As is well known in the art of low energy nuclear reactions, palladium is the best absorber of hydrogen isotopes, although scandium and titanium show similar characteristics. Various alloys of those metals can also be used as electrodes (2). In palladium the hydrogen atoms form layers in between the layers of palladium atoms in the metal's crystalline structure. Ultimately it is possible to achieve D and/or T densities that approach the density of liquid hydrogen. Due to palladium's high cost, titanium targets are the targets of choice for use in most fusion accelerator tubes.

When ionized vapor (3) strikes the electrode (2) it loses some of its energy and gives off a bremsstrahlung x-ray. Electrons accelerated the opposite direction also produce bremstrahlung x-rays. The amount of energy lost in the collisions varies tremendously. Some of that vapor will be deflected into an adjacent D or T atom after losing some energy and still produce fusion. The optimal operating voltage is somewhat higher than the optimal cross-section energy for a given fusion reaction. For example D-T reactions have an optimal cross section energy of 100 kV so the optimal operating voltage will likely be in the 120 to 150 kilovolt (kV) range.

The minimum electrode (2) spacing is dependant on the voltage and the vapor (3) as the path length needs to be long enough that the vapor has time to accelerate. This generally takes several centimeters. A 30 cm path length was used in initial experiments. When vapor (3) is introduced through an inlet (9) the inlet is normally positioned at least 10 cm from an electrode. The distance between electrodes may be increased in order to increase the number of fusion events per arc. With the vapor being accelerated at near the speed of light the maximum distance could be many times the 30 cm length. There may be a benefit to having longer path lengths as there is more vapor (3) available within the tube initially to produce greater fusion output. Additionally smaller fraction gets absorbed per arc, which helps to maintain pressure in the tube.

Three other atoms lithium-6, lithium-7 and boron-11 are of interest for producing fusion, however the cross sections are much lower and it is not expected that they would work well in a fusion tube in vapor (3) form. For these three isotopes it would be best to incorporate them into alloys either separately or in combination that could be used as electrodes (2). All three of those isotopes fuse with hydrogen-1, so hydrogen-1 would be the vapor (3). Lithium-6 also fuses with deuterium, so deuterium could be used as the vapor (3) as before with an electrode (2) comprising an alloy with lithium-6. The advantage of using hydrogen as a fusion vapor (3) is that those reactions produce fewer neutrons, which may be advantageous in some power applications, particularly vehicles where radiation exposure to humans needs to be avoided. The H-¹¹B interaction is aneutronic and is often considered the preferred fusion interaction for such things as space vehicles. Pure boron and most boron compounds are non-conductive and not suitable for use as electrodes. Pure lithium metals have a low melting point and are therefore not suitable for use as electrodes. Lithium-boron alloys are conductive and have been shown to have melting points around 600^{c}, and may be useful short term. The addition of magnesium in concentrations of approximately 10% forming a lithium-boron-magnesium alloy has been shown to have a melting point of nearly 1200 (U.S. Pat. No. 5,156,806 to Satula et al.). An electrode (2) comprising such an alloy with vapor (3) comprising mostly hydrogen is an example of a preferred embodiment when lithium or born is used.

FIG. 1 also illustrates the use of some simple capacitors (4) shown here as metal spheres. The capacitance of the coil (12) or transformer (11) plus the capacitance of a separate capacitor (4) if used must be sufficient to store enough energy to produce arcs at the desired voltage. The coil (12) and capacitor (4), if used, form a resonant RLC circuit. For optimal efficiency this part of the system should resonate, storing energy and sending it back through the tube until it can all be used for fusion or converted into x-rays or waste heat. The capacitors (4) will generally only need to be a few picofarads, so spheres or toroids of the type used for small Tesla coils are preferred. Plate capacitors, vacuum capacitors or other high-voltage capacitors known to that art may also be used.

The tube in FIG. 1 is shown as a flow through design with an inlet (9) and an outlet (10). In an alternative embodiment there may only be an inlet (9) to replace vapor (3) as it is used and absorbed. Vapor (3) will be leaked into the inlet (9) by way of a leak valve plumbed to a source of vapor. The outlet (10) is attached to a vacuum system. In tests the vacuum pump was a Wheeler diffusion pump made entirely of borosilicate. The entire vacuum system was made on non-conductive materials to prevent stray arcs. Quartz or ceramics could be used for higher temperature vacuum components. The system also included a liquid nitrogen trap, a roughing pump and vacuum pressure gauges. The high vacuum gauge in the test system was a battery powered thermocouple gauge with optically isolated output, so that it did not provide a ground path. Isolation from ground may not be critical for all systems, but for optimal efficiency and performance stray electrical grounds should be eliminated.

This vacuum system should only serve as an example of the technology that may be used as any vacuum system capable of achieving vacuum in the 10⁻⁵ Torr range is acceptable. The leak valve is adjusted so as to maintain a constant pressure inside the tube. The arcing voltage is determined by the tube configuration and pressure, as the coil will generally produce whatever voltage is necessary for an arc to occur. The Paschen curve, breakdown voltage versus pressure, must be determined for each vapor (3) and fusion tube design. In general breakdown voltages necessary for fusion in the 10 kV to 500 kV range will require pressures in the 1×10⁻³ torr to 1×10⁻² torr range.

FIG. 2 contains some additional alternative embodiments of the fusion tube design. The envelope (1) is larger and has cooling tubes (7) built into it where heat transfer fluid can flow. The cooling tubes could be used for cooling or they could be used for directly heating fluid for power generating. For example the envelope could function as a steam generator. If the envelope is submersed in a heat transfer fluid, features to increase its surface area such as fins (8) could be used to increase heat transfer rates. The fusion tube can also be air-cooled as is typical in most fusion accelerator tube applications. Much of the heat will be transferred from the envelope (1) by the electrodes (2) so electrode cooling will also be important in high-power applications to maintain the integrity of the vacuum tight seal between the electrodes (2) and the envelope (1). For energy production the ultimate goal will most commonly be to produce steam to drive a steam turbine. The steam can be produced directly or there may be a primary heat transfer fluid and a steam generator that converts the heat of the primary fluid to steam. Commonly considered primary fluids for use in fusion include water, sodium and helium. Sodium has the added benefit of being a good breeder material for tritium. Water can also be used to breed deuterium and tritium. Oil or silicone fluid are examples of lower temperature primary heat transfer fluids that could be chosen.

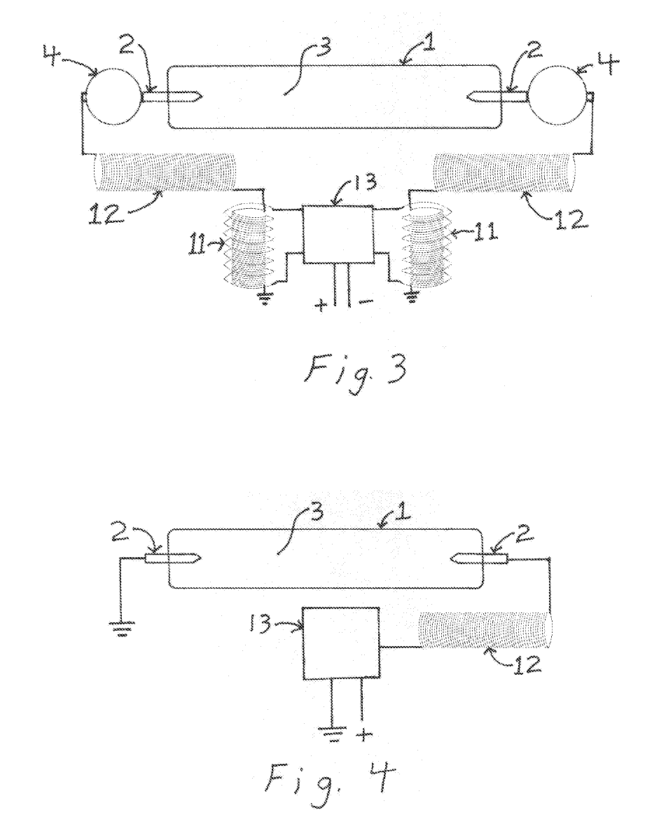

FIG. 3 illustrates another embodiment of the invention with an additional coil between the inverter (13) and a resonant coil (12), magnetically coupled to the resonant coil thus forming a transformer (11). In a magnetic coupling the base of the secondary coil of the transformer (11) is wired to ground rather than to the primary coil and all energy is transferred to the secondary magnetically. A two transformer configuration is illustrated in FIG. 3. This additional coil, the transformer primary, only needs a few turns. 5 to 20 turns is typical in a Tesla type air transformer shown here. The turn ratio or more properly the inductance ratios yield a greater voltage increase then can be achieved with a coil alone. By magnetically coupling the two coils the resonant coil is free to resonate with less potential for damaging to the inverter. The inverter does not have to operate at as high a voltage and is not subject to as high reverse voltages. The transformer primary and secondary need to be separated by distance or well insulated to avoid having high voltage arcs form between them that could destroy the inverter.

In order to achieve additional voltage gain and isolation from the inverter (13) the original coil (12) can be retained and a complete transformer (11) added between the inverter and the coil as is shown in FIG. 3. A capacitor (4) can also be added in series between the coil (12) and electrode (2) to add additional capacitance to the circuit and tune the resonant frequency. All together this forms what is known as a Tesla Magnifier when the output of a transformer is attached to a third coil that is allowed to resonate freely. FIG. 3 shows a twin Tesla Magnifier configuration, but it is easy to see that a resonant circuit can be achieve with one side at high voltage and the second going to ground. The transformers and/or coil may be immersed in an insulating fluid and they may have magnetic cores to increase their energy storage capacity. The air core coils and/or transformers are used as examples throughout due to their simplicity but other forms of high-voltage transformer known to the art may be used.

An alternative embodiment shown in FIG. 5 shows a two secondary transformer (14). It has a single primary coil and two secondary coils. The secondaries are grounded near the middle and reach high-voltage on the outer ends. The secondaries of this type of resonant transformer (14) may be attached directly to the fusion tube electrodes (2), or there may be a coils (12) and/or capacitors (4) between the two secondary transformer (14) and the electrodes (2). The two secondary transformer (14) can replace both transformers shown in FIG. 3.

The inventor is unaware of any prior attempts to ever accomplish nuclear fusion in an accelerator type device using a resonant high-voltage AC power supply. This is likely due to two factors, the first being that most high-voltage test equipment is DC and secondly that it is generally viewed that the energy expended on collisions between the vapor and electrode is wasted making it impossible to approach break even. This invention is designed to ensure that almost all the energy put into the power supply is converted to vacuum arcs. The vacuum arc energy that does not produce fusion produces heat and light, including x-rays. For power applications the x-rays and other light can be entirely reabsorbed and converted to heat therefore having very little wasted energy. All the combined heat including heat from fusion is then used for power generation. In this manner the fusion efficiency only needs to be high enough to overcome the energy loses in the power supply and ancillary equipment.

There are several additional ways in which this invention outperforms prior inventions. The more rapidly the arc is quenched and the magnetic field collapses the more energetic the current pulse and greater the fusion output. For fixed energy pulses, as the number or arcs per second increases the fusion output increases proportionately. There is a threshold for the minimum amount of energy that can produce an arc. In one test apparatus with conical electrodes and a 30 cm gap, the minimum energy was approximately 15 millijoules. The resonant power supply needs to be designed such that the high-voltage power supply forms a resonant RLC (Resistance-Inductance-Capacitance) circuit. These circuits can be made very efficient with almost all the energy being available for arc production. In the preferred embodiment of the invention high-voltage resonator coils along with some additional capacitance are connected to opposing electrodes (2) so that energy can resonate back and forth producing arcs at very high frequency independent of the secondary transformer.

The use of resonant high frequency high-voltage AC was pioneered by Nikola Tesla and design guidance can be found by studying his Tesla Coil designs. The preferred embodiment of the power supply is equivalent to a twin Tesla magnifier. General solutions for tuning a resonant Tesla magnifier circuit and other circuits described herein have been published by A. C. M. de Queiroz. Those solutions deal with the coupled LC resonance taking advantage of the fact that resistance can largely be neglected in these types of circuits. Additionally the preferred embodiment takes into account the native quarter wave resonance of the coils, which is related to the time it takes for a current pulse to travel the length of the coil.

In a twin Tesla magnifier coupling constants can be established giving the frequency ratios between the primary (k), secondary (l) and tertiary (m) circuits. The primary circuit includes the primary capacitors, the inverter (13) and the primary coil of the transformer (11). The secondary circuit includes the secondary coil of the transformer (11) and possibly an additional capacitor. The secondary capacitor, if needed, to tune that part of the circuit is best placed on the ground side and may be a high-voltage plate, vacuum capacitor, or other high voltage capacitor design know to the art. The tertiary circuit includes the resonant coil (12) and capacitor (4). It is normal to neglect resistance during design and allow for some adjustment, but ideal design of the circuit should take resistance into account.

Within the scope of the de Queiroz solutions the coupling coefficients k:l:m chosen as the best for this invention were 3:4:11 however other ratios may be better for different topologies or components. This choice allows the resonant coil to resonate at a much high frequency than the inverter so it can be matched to the native quarter wave resonance of the resonant third coil. Given those coefficients the coupling coefficient of the transformer squared needs to be 0.25, and the inductance ratio of the tertiary to secondary coils L₃/L₂=2.96. Both of those can be easily accomplished and are known to near ideal in a resonant Tesla coil circuit. By careful selection of the materials and parameters it is possible to create a high-frequency high-voltage power supply where nearly 100% of the energy from the power supply can reach the fusion tube. The resonant coils next to the tube can then continue to resonate at their native frequency producing arcs until there is no longer enough energy to form an arc. In FIG. 3 the coils (12) are shown magnetically coupled, aligned along the same axis, and counter-wound so that the discharge of one charges the other. This conserves energy and causes the magnetic field produced by the arc to collapse as rapidly as possible producing a higher energy pulse. In this manner nearly all the initial energy leads to vacuum arc production thus maximizing the number of fusion reactions and consequently neutron and energy output. While optimal resonance of the coils can be achieved with the twin Tesla magnifier configuration shown in FIG. 3, other topologies incorporating a resonant AC circuit described in the claims also show an improvement relative to a DC driven fusion tube design.

For well-logging and uranium mining a simpler version of power supply is preferred due to the space limitations of logging tools. The tube itself will also need to be air-cooled. D-D fusion tubes will be preferred for those applications given sufficient neutron output as they have a lower regulatory burden and the neutron energy is closer to the typical AmBe source used by the industry. For and isotope production a full-scale twin Tesla magnifier or similar non-air-core power supply powering a fusion tube run primarily D-T fusion would be optimal. Neutron activation analysis could be performed with any system depending on neutron output requirements, as size is usually not an issue outside of underground mining applications. For power production the embodiment shown in FIG. 3 is preferred. Multiple tube and power supply units can be utilized to produce more energy.

The embodiments of the invention in which an exclusive property or privilege is claimed are defined as follows:

1. An apparatus for producing nuclear fusion comprising:
a high-frequency inverter,
a resonant coil, and
a fusion tube comprising:
a non-conductive vacuum envelope,
two electrodes, and
a vapor consisting of atoms that are known to participate in fusion reactions.

2. An apparatus in claim 1 wherein the electrodes are comprised of a metal that is known to absorb hydrogen

3. An apparatus in claim 2 wherein the electrodes are principally comprised of palladium, scandium or titanium.

4. An apparatus in claim 2 wherein the electrodes are comprised of an alloy of lithium, boron or a combination of both.

5. An apparatus in claim 1 wherein the electrodes are hollow.

6. An apparatus in claim 1 wherein the envelope has internal ridges or rings.

7. An apparatus in claim 1 wherein the envelope as features to increase external surface area consisting essentially of fins.

8. An apparatus in claim 1 wherein the envelope has internal tubes for circulating heat transfer fluids.

9. An apparatus in claim 1 wherein the envelope is comprised of a compound containing lithium.

10. An apparatus in claim 1 wherein the vapor is, deuterium, tritium, helium-3, hydrogen-1, or any mixture thereof.

11. An apparatus in claim 7 wherein a noble gas is added to the vapor.

12. An apparatus in claim 1 wherein a capacitor is added between the coil and the electrode.

13. An apparatus in claim 1 wherein two coils are added with one in series with each electrode.

14. An apparatus in claim 1 wherein two capacitors are added with one in series with each electrode.

15. An apparatus in claim 14 wherein the two added coils are wound in opposite directions

16. An apparatus in claim 1 wherein a second coil is placed in series with the inverter and magnetically coupled to the first coil forming a transformer.

17. An apparatus in claim 16 wherein the transformer has two secondary windings wound in opposite directions.

18. An apparatus in claim 16 wherein two transformers are utilized, one for each electrode, with their secondary windings wound in opposite directions.

19. An apparatus in claim 18 wherein two coils are added with one between the transformer and electrode on each side of the tube.

20. An apparatus in claim 19 wherein the coils lie along the same axis.

21. An apparatus in claim 1 wherein the fusion tube is sealed.

22. An apparatus in claim 1 wherein the fusion tube has an inlet for the vapor.

23. An apparatus in claim 23 wherein the fusion tube has an outlet for the vapor attached to a vacuum system.
